(19) United States
(12) Patent Application Publication
(10) Pub. No.: US 2025/0272634 A1
(43) Pub. Date: Aug. 28, 2025

(54) SYSTEMS AND METHODS FOR WATER RESOURCE MANAGEMENT

(71) Applicant: SAUDI ARABIAN OIL COMPANY, Dhahran (SA)

(72) Inventors: Ibrahim S. NASSAR, Dhahran (SA); Ayedh J. ALGHAMDI, Almontazah (SA); Asem G. ALSADEQ, Al Khobar (SA); Mana M. ALOWAIDH, Dhahran (SA); Yasser A. ALSHAALAN, Dammam (SA); Fahad A. AL-KHALDI, Khobar (SA)

(73) Assignee: SAUDI ARABIAN OIL COMPANY, Dhahran (SA)

(21) Appl. No.: 18/589,201

(22) Filed: Feb. 27, 2024

(51) Int. Cl. G06Q 10/0631; G06Q 50/06

(52) U.S. Cl. CPC G06Q 10/06313; G06Q 50/06

(57) ABSTRACT

Water resource management tools including an identifier, executed by a processor, to generate data identifying a set of alternative water resources for a project based on data characterizing a location and data characterizing a set of water characterizations of the water resource, a matcher, executed by the processor, to match one or more treatments or technologies to each alternative water resource of the set of alternative water resources based on the set of water characterizations, and a levelized value engine to determine a levelized value for the water resource based on the data identifying the set of alternative water resources, data characterizing the one or more treatments or technologies and the one or more expenditures of water treatment and transportation for each alternative water resource, the determined levelized value being used to cause one or more of the set water resource to be delivered to the project.

### FIELD OF THE DISCLOSURE

This disclosure relates generally to water resource management.

### BACKGROUND OF THE DISCLOSURE

Project lifecycles include multiple stages, such as planning, construction, operation, or other like labels. A project may be land development for agricultural purposes, housing, resource production, or a new facility, for instance. Regardless of the type of project or the lifecycle stage of the project, managing water resources throughout the life of the project is important to ensuring the health and safety of people, assets, and the environment.

Not only is water resource management important to health and safety, but water resource management is also challenging. Conventional water resource management approaches may treat a water resource, such as groundwater, as an unlimited or readily available resource. However, availability of a water resource may change not only during normal weather cycles in a region, but also as climate shifts or as the water resource is depleted or degraded. The water resource may be depleted due to overconsumption or degraded due to pollution, for instance. Variances in water resource availability may lead to an increased likelihood of depletion of one or more water resources during a lifecycle of a project.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a water resource management tool includes a water resource management (WRM) tool includes an identifier, executed by a processor, to generate data identifying a set of alternative water resources based on data characterizing a location of a project using a water resource and data characterizing a set of water characterizations of the water resource, a matcher, executed by the processor, to match, using a matching model, one or more treatments or technologies to each alternative water resource of the set of alternative water resources based on the set of water characterizations, and a levelized value engine, executed by the processor, to determine a levelized value of the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project . . .

In another embodiment consistent with the present disclosure, a method for water resource management includes identifying a set of alternative water resources based on data characterizing a location of a project using a water resource and data characterizing a set of water characterizations of the water resource, matching one or more treatments or technologies to each alternative water resource of the set of alternative water resources based on the set of water characterizations, and determine a levelized value for the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project.

According to another embodiment consistent with the present disclosure, a non-transitory computer-readable medium is configured to store computer-executable instructions, which, when executed by a processor, cause the processor to identify a set of alternative water resources based on data characterizing a location of a project using a water resource and data characterizing a set of water characterizations of the water resource, match one or more treatments or technologies to each alternative water resource of the set of alternative water resources based on the set of water characterizations, and determine a levelized value for the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project.

Any combinations of the various embodiments and implementations disclosed herein can be used in a further embodiment, consistent with the disclosure. These and other aspects and features are better appreciated according to the following description of certain embodiments presented herein in accordance with the disclosure and the accompanying drawings and claims.

### BRIEF DESCRIPTION OF THE DRAWINGS

FIG. 1 is a block diagram of a system for a water resource management tool, in accordance with certain embodiments.

FIG. 2 is a block diagram of a system implementing a water resource management tool, in accordance with certain embodiments.

FIG. 3 is a flow diagram of a method for a water resource management tool, in accordance with certain embodiments.

FIG. 4 is an example user interface for a water resource management tool, in accordance with certain embodiments.

FIG. 5 is an example user interface for a water resource management tool, in accordance with certain embodiments.

FIGS. 6A-6B is an example user interface for a water resource management tool, in accordance with certain embodiments.

FIG. 7 is an example user interface for a water resource management tool, in accordance with certain embodiments.

FIG. 8 is a block diagram of a system implementing a water resource management tool, in accordance with certain embodiments.

FIG. 9 is a block diagram of a system that can be employed to implement a water resource management tool, in accordance with certain embodiments.

FIG. 10 is a block diagram of a computer system that can be employed to implement a water resource management tool, in accordance with certain embodiments.

### DETAILED DESCRIPTION

Embodiments of the present disclosure will now be described in detail with reference to the accompanying Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to managing water resources during a project lifecycle. “Water resources,” as used herein, describes an origin of a type of water. The types of water may include groundwater, river water, lake water, seawater, wastewater, harvested water (e.g., captured rainwater, captured stormwater, captured condensate water, captured snowmelt, glacier water, iceberg water, or the like). The water resource may be a specified lake, river, groundwater area, sea, water treatment plant, or the like, for example. A project may include conservation of a body of a natural water resource or land development for agricultural purposes, housing, resource production, or industrial or commercial facilities (e.g., business centers, manufacturing, heavy industry, storage, distribution, refineries, retail centers, or the like), for example. “During a project lifecycle,” as used herein, is inclusive of one or more stages of that project. A conservation project may be a project to protect a specified water resource from depletion or degradation, for example. A project lifecycle of the conservation project can include multiple stages such as planning, implementation, monitoring, and evaluation, or other like labels. A resource production project may be a well field for oil and gas exploration, for example. A project lifecycle of the well field can include multiple stages, such as planning, drilling, completion, production, and shut in, or other like labels. A project lifecycle of an industrial facility can include multiple stages, such as planning, building, operations, decommissioning, or other like labels, for example.

A water resource management tool is disclosed herein that shifts a paradigm from a conventional reactive approach to a proactive approach. The water resource management tool enables one or more stages of a project lifecycle to be targeted to determine how to allocate a water resource to one or more projects to satisfy demand for the water resource between the one or more projects, which may include conservation projects, agricultural projects, housing projects, resource production projects, industrial or commercial projects. The tool aids in reducing pressure on the water resource by computing a levelized value for the water resource. The levelized value for the water resource may then be utilized to determine (or identify) comparable alternative water resources based on water characterizations of the water resource. One or more of the comparable alternative water resources may then be used to replace and/or supplement the water resource. Replacing and/or supplementing the water resource aids in conserving the water resource by preventing its depletion and/or degradation, thereby preventing a cost for the water resource from increasing due to depletion and/or degradation.

In a conventional approach, the project lifecycle may include using a readily available water resource, such as a natural freshwater resource. Natural freshwater resources (e.g., rivers, lakes, groundwater) are often assumed to be free. However, using the readily available water resource may result in these resources becoming scarcer. The term “scarcity,” or its derivatives as used herein, indicates that the water resource is in danger of being consumed, and/or deteriorating due to its limited quantity and/or quality. Thus, in some instances, other projects upstream, downstream, or in an otherwise specified area or region of the project may result in the readily available water resource becoming scarcer during the project lifecycle.

Water scarcity is hazardous to the health and safety of people, assets, and the environment. For instance, in a well field project, water is used not only by personnel on site, but also by equipment. During drilling operations for the well field project, water may be used in drilling fluids to aid in stabilizing subsurface formations, removing cuttings from a wellbore, and cooling and lubricating a drill bit. Therefore, water scarcity could result in hazardous operating conditions for people, assets, and the environment, including production downtime while one or more additional water resources are sought. Supplementing or replacing the scarce water resource may also increase operation costs associated with a project by adding unplanned costs for infrastructure, transportation, or a combination thereof. While projects may result in more food, housing, resources, jobs, or the like, conventional water resource management during the project lifecycles may also result in water resource scarcity.

According to certain embodiments, a water resource management tool (e.g., implemented as machine-readable or computer-executable instructions) includes a treatment identifier, a matcher, a financial modeler, and a levelized value engine. The treatment identifier can identify a set of alternative water resources based on a location of a project using a water resource and on a set of water characterizations of the water resource. The matcher can determine by a matching model one or more treatments or technologies for each alternative water resource of the set of alternative water resources based on the set of water characterizations. The matching model can compare parameters of the one or more of treatments or technologies to the set of water characterizations. The financial modeler can determine by a financial model one or more costs of water treatment and transportation for each alternative water resource of the set of alternative water resources based on the one or more treatments or technologies. The levelized value engine can determine a levelized value for the water resource based on the set of alternative water resources, the one or more treatments or technologies, and the one or more costs of water treatment and transportation. The term “levelized value” refers to a calculated worth of a resource or asset (e.g., the water resource, the one or more secondary water resources) over a lifecycle of a project utilizing the resource or asset. The levelized value for the water resource may be measured as a ratio of fixed cost to cubic meter (e.g., $/m3). The determined levelized value is used to cause one or more of the set of alternative water resources and/or the water resource to be delivered to the project.

In some examples, the water resource management tool allows for water resource management throughout a project lifecycle by determining a levelized value for water resources (e.g., natural freshwater resources) that are assumed free under conventional approaches. Determining the levelized value (e.g., the value for the water resource is equivalent to the cost of replacement upon depletion with the most cost-effective alternative water resource) adheres to the well-established economics concept referred to as the deprival value, which states that a resource that has been fully consumed will be replaced with the most cost-effective alternative. The water resource management tool enables the efficient consideration of multiple replacement options given a number of alternative water resources having multiple different treatment options, each of which may have multiple different technology options, as well as costs associated with the different treatment and technology options. The levelized value computed by the water resource management tool provides support engineers, government utility agencies, and environmental regulators with an efficient approach for making educated decisions on one or more of the use, protection, or billing structure for the water resource.

In some examples, the tool can be used to identify alternative water resources (e.g., the one or more secondary water resources) to reduce pressure on a scarce water resource. The water resource management tool also provides financial benefits such as by reducing costs, such as when less expensive water resources become available. For example, another project in the area may shift to an alternative water resource. The shift to the alternative water resource may reduce transportation costs for the alternative water resource, reduce pressure on a scarce water resource, or a combination thereof. The shift results in lower costs as well as increased availability for both the once-scarce water resource and the alternative water resource. Managing water resources throughout the project lifecycle is important to ensuring the health and safety of personnel, assets, and the environment. For example, consideration of treatments using renewable energy technologies by the water resource management tool promotes sustainable methods for water treatments, conveyance systems, or a combination thereof. Furthermore, utilizing the water resource management tool to find alternative water resources based on water characterization may help direct wastewater reuse to compatible projects.

In some examples, the water resource management tool can be used by a variety of entities, such as governmental or industrial. Industrial entities may be from a variety of different industries, such as the agricultural industry, the housing industry, the construction industry, the oil and gas industry, the mining industry, the quarry industry, the hydrological industry, the liquid waste disposal industry, the geothermal energy industry, the geologic greenhouse gas storage industry, the manufacturing industry, or like industries in which water resources are utilized. Thus, the water resource management tool as described herein can be used in any environment or industry that requires or needs water resource management.

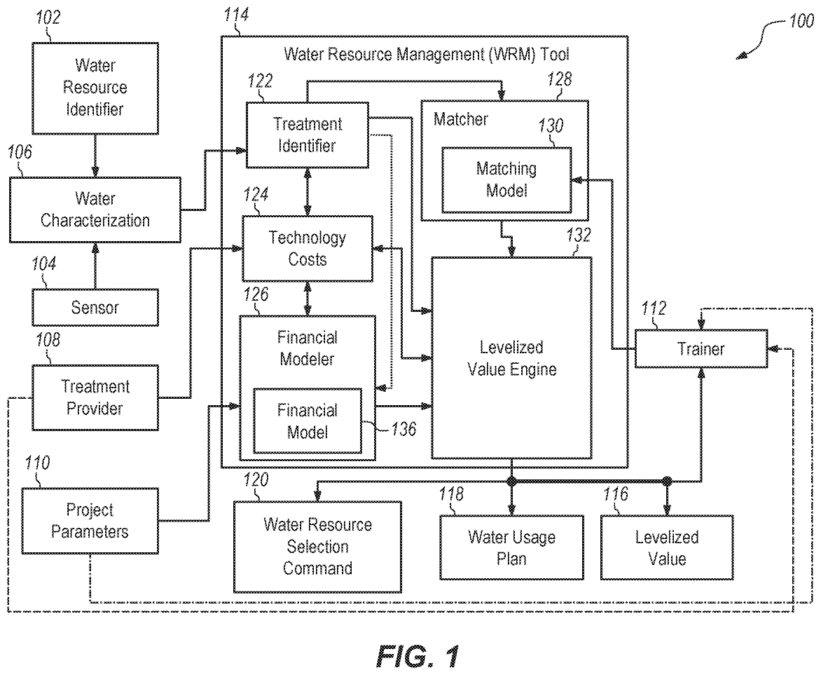

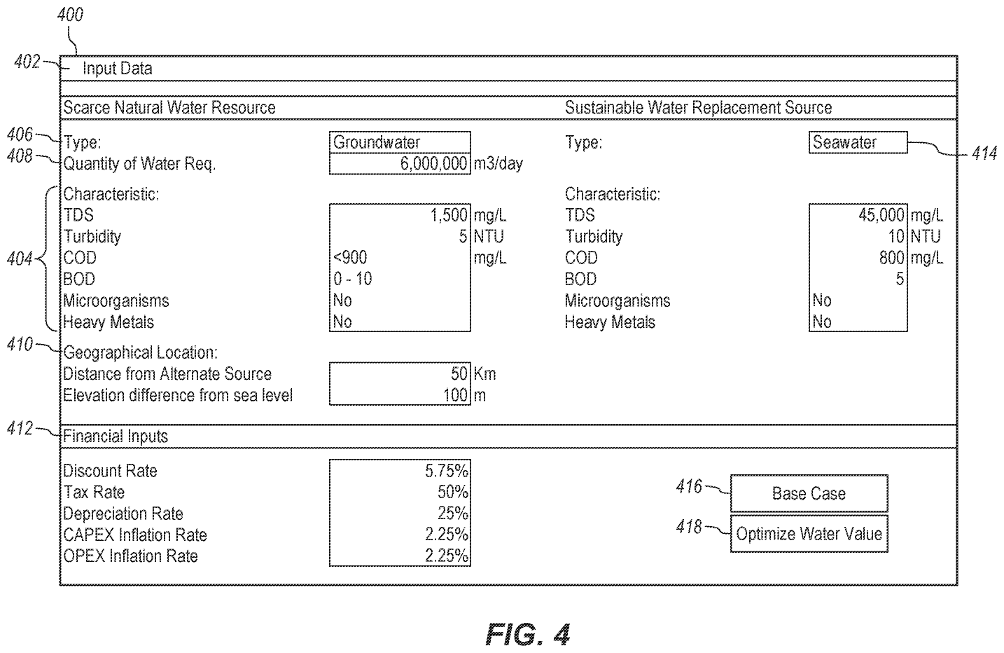

FIG. 1 is an example of a system 100 for a water resource management (WRM) tool 114 that is configured to receive one or more of a set of water characterizations 106 for a water resource, and data associated with one or more treatments or technologies. The WRM tool 114 can also receive a set of project parameters 110. A “set,” as used herein may include zero or more of specified items (or data points). The WRM tool 114 may receive data of the set of water characterizations 106, data of the set of project parameters 110, or a combination thereof, as inputs, in some instances, via a user interface (UI), for example. The UI may be a UI as described with respect to FIG. 4, for example.

In certain embodiments, the set of water characterizations 106 may include at least one of a total dissolved solid, a turbidity, a carbonate level, a potential of hydrogen (pH) level, a hardness, a sodium level, a chloride level, a nitrate level, a microorganism presence, a heavy metal content, a toxin content, a pollutant content, a sodium absorption rate, a chemical oxygen demand (COD), a biochemical oxygen demand (BOD), or other like characteristics. The data associated with the one or more treatment or technologies may include one or more of a plurality of water resources, water characterizations of each water resource of the plurality of water resources, a set of treatments, a set of technologies, capital costs, operational costs, transportation costs, or the like. “Treatments,” as used herein, refers to a process for treating a water resource, while “technologies” refers to equipment used in performance of the process.

In certain embodiments, the set of project parameters 110 may include one or more of a project location, a project size, a project configuration, a type of the water resource having the water characterizations 106, an electrical power usage, labor resources, a transmission capacity, capital costs, sustaining capital costs, energy values, labor costs, chemical costs, waste costs, maintenance costs, insurance costs, an escalation rate, an inflation rate, a depreciation rate, a tax rate, or a discount rate. The project location may indicate a geographical area, a latitude, a longitude, an elevation above sea level, one or more distances from one or more water resources, or other like coordinates for determining a location on a map, for example. The project size may include a quantity of the water resource to be used in one or more stages of the project or a quantity of water to be used daily by the stage of the project, for example. The project configuration may indicate one or more locations within the project location to which the water resource is to be delivered. In a non-limiting example, the set of project parameters 110 may include one or more of a facility location, a facility size, a facility configuration, an electrical power usage, labor resources, a transmission capacity, capital costs, sustaining capital costs, energy values, labor costs, chemical costs, waste costs, maintenance costs, insurance costs, an escalation rate, or a discount rate. The WRM tool 114 is further configured to determine a levelized value 116 for a water resource having the set of water characterizations 106, in accordance with certain embodiments.

In a non-limiting example, the set of water characterizations 106 may be received from one or more of a water resource identifier 102, a sensor 104, a treatment provider 108, or other sources (not shown). The other sources may include manually recorded surveys like laboratory testing results on water samples, or the like, for example. The water resource identifier 102 may include a UI that enables a user to input one or more of a water resource, data of the set of water characterizations 106, a quantity of water to be supplied per day, or a combination thereof, for example. The UI may be a UI as described with respect to FIG. 4, for example. The sensor 104 may include one or more of a pH sensor, a conductivity sensor, a residual chlorine sensor, a total dissolved solids (TDS) sensor, a turbidity sensor, a dissolved oxygen sensor, an oxidation reduction potential (ORP) sensor, a chemical oxygen demand (COD) sensor, a biochemical oxygen demand (BOD) sensor, an ammonia nitrogen ion sensor, a chlorophyll sensor, a blue-green algae sensor, an ion probe sensor, an electrochemical sensor, or other like sensors for measuring one or more chemical, physical, or biological reactions in a water resource. The treatment provider 108 may be a facility or plant using one or more technologies to provide one or more treatments of water resources. The treatment provider 108 may use one or more treatments, such as adsorption, air stripping, chemical oxidation and reduction, ultraviolet oxidation, photocatalysis, filtration, membrane separation, ion exchange, metal sequestration, oil water separation, pH control, precipitation, coagulation, flocculation, reclamation, disinfection, softening, reverse osmosis, electrodialysis, nano-filtration, distillation, or other like treatments that modify one or more water characteristics of a water resource. The treatment provider 108 may use one or more technologies to perform the treatment, where the one or more technologies are associated with one or more of utility technologies, energy recovery technologies, or treatment technologies, each of which may have different operational levels and/or operational constraints. The treatment provider 108 may be an activated sludge plant, an agricultural wastewater treatment plant, a sewage treatment plant, an effluent treatment plant, a harvesting water system, a water desalination plant, or other like systems for collecting and/or treating water resources, for example.

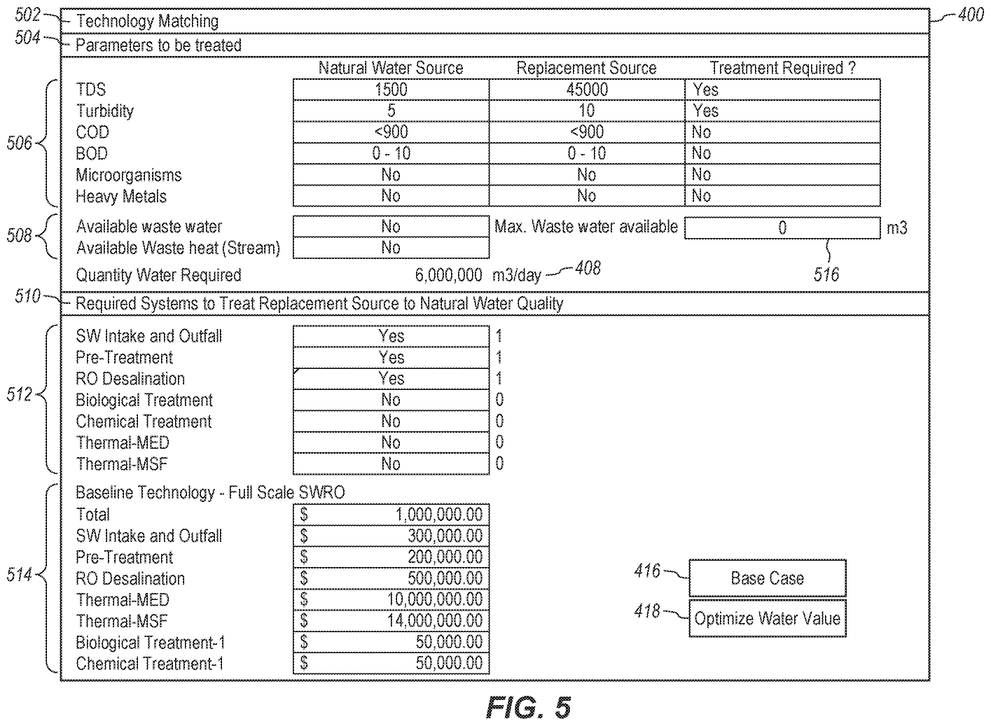

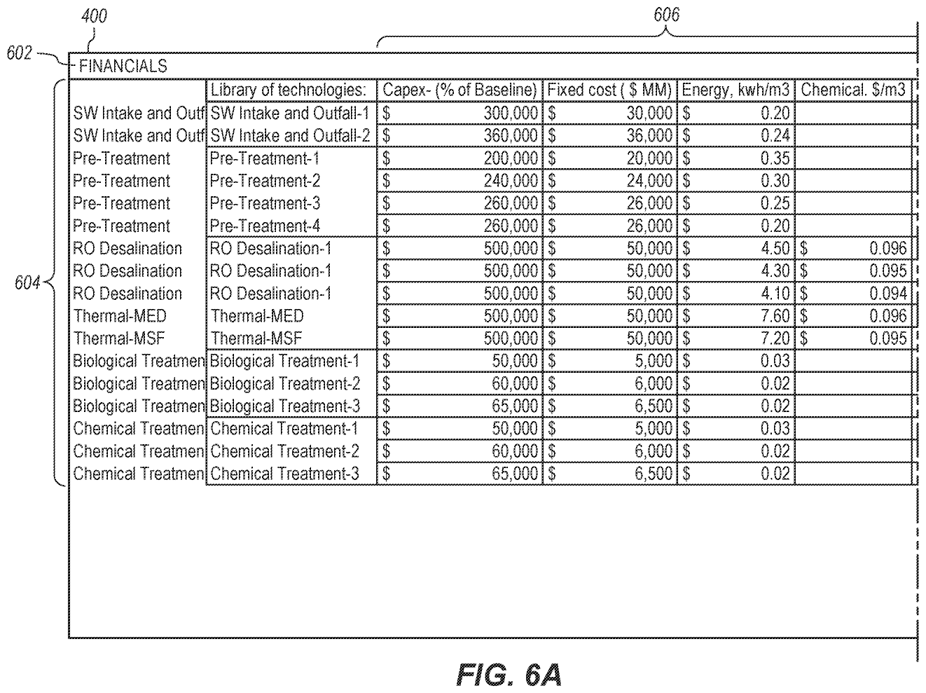

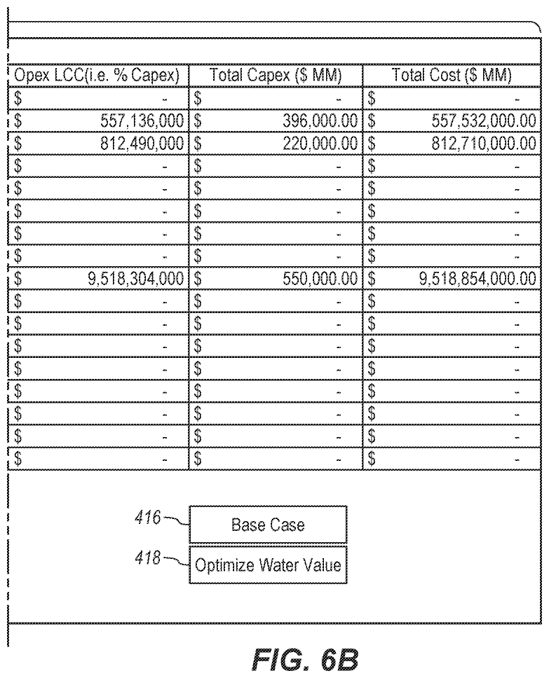

In a non-limiting example, the treatment provider 108 may provide the data associated with one or more treatments or technologies. In certain embodiments, the WRM tool 114 includes a technology costs database 124 configured to receive and store the data associated with the one or more treatments or technologies. The technology costs database 124 may be stored to a computer-readable medium or storage device as described with respect to FIG. 5 or 6, for example. The technology costs database 124 may be configured to receive the data associated with the one or more treatments or technologies at specified intervals (e.g., daily, weekly, monthly, or the like), or at random intervals, and independent of other operations performed by the WRM tool 114.

The WRM tool 114 includes a treatment identifier 122 that is configured to receive data identifying one or more of a water resource, the set of water characterizations 106 of the water resource, a type of an alternative water resource, and/or the set of project parameters 110. In certain embodiments, the treatment identifier 122 identifies a set of alternative water resources based on one or more of a location of a project using the water resource, the set of water characterizations 106 of the water resource, and the type of the alternative water resource. The treatment identifier 122 can identify similar water sources (e.g., a set of alternative water resources) to the water source. In a non-limiting example, the treatment identifier 122 may limit the set of alternative water resources to include alternative water resources of the type (e.g., seawater) received as an input. In various embodiments, the treatment identifier 122 is configured to retrieve from the technology costs database 124 data identifying the set of alternative water resources and corresponding locations. In a non-limiting example, the treatment identifier 122 compares the location of the project using the water resource to one or more locations of available water resources stored to the technology costs database 124. In some examples, the treatment identifier 122 may determine whether each location of the one or more locations is within a specified range of the location of the project. “Specified range,” as used herein, indicates that a value is within a +/−percentage or is between a lower and upper limit, or the like. The specified range may be input by a user using a UI, such as described with respect to FIG. 4. The treatment identifier 122 compares the set of water characterizations 106 to water characterizations for each of the available water resources within the specified range to identify one or more alternative water resources.

Determining one or more alternative water resources based on the set of water characterizations 106 ensures that the one or more alternative water resources is a suitable alternative for the water resource. “Suitable,” as used herein, indicates that the one or more alternative water resources may fulfill the purpose of the water resource, be used to produce similar results, and/or cause fewer problems than other alternative water resources if substituted. The one or more alternative water resources can share or have similar water characterizations as the set of water characterizations 106 for the water source. In some examples, a threshold can define a number of required water characterizations that the one or more alternative water resources should share with the water resource, and only the alternative water resources with a number of water characterizations that is greater than or equal to the threshold are identified by the treatment identifier 122.

In some examples, the WRM tool 114 includes a matcher 128 that is configured to receive data characterizing the set of alternative water resources identified by the treatment identifier 122. The matcher 128 includes a matching model 130 that can be configured to determine (or identify) one or more treatments or technologies for each alternative water resource of the set of alternative water resources based on the set of water characterizations 106. In certain embodiments, the matching model compares data of the one or more of treatments or technologies stored to the technology costs database 124 to the data characterizing the set of water characterizations 106.

In a non-limiting example, the matching model 130 can be configured to associate (e.g., logically link and store in memory, for example, as disclosed herein) one or more treatments or technologies to each alternative water resource of the set of alternative water resources by determining whether use of the one or more treatments or technologies on each alternative water resource of the set of alternative water resources results in the alternative water resource having water characterizations that are similar to the set of water characterizations 106. In various embodiments, the matcher 128 determines, using the matching model 130, whether one or more treatments or technologies are associated with sets of water characterizations that are within a specified tolerance of the set of water characterizations 106. For example, the set of water characterizations 106 may include a pH of 6.7 and the specified tolerance may be a specified range (e.g., +/−a percentage, lower limit to upper limit, or the like). The specified tolerance may be input by a user using a UI, as described with respect to FIG. 4, for example.

In certain embodiments, the matcher 128 can determine whether the one or more treatments or technologies are usable based on one or more technology selection criteria. In a non-limiting example, the one or more technology selection criteria can be input by the user using a UI as described with respect to FIG. 4. In another non-limiting example, the one or more technology selection criteria can be included in the set of project parameters 110.

In some examples, the matching model 130 is provided by a trainer 112. The trainer 112 can be implemented as a machine-learning algorithm that can be configured to train the matching model 130 based on one or more performance curves for the one or more treatments or technologies. The machine-learning algorithm may use a regression and error minimization technique, for example. The performance curve provides a relationship between an output of the one or more treatments or technologies and energy consumption. The relationship may be kilowatt hours per ton (Kwh/ton), for example. In a non-limiting example, the one or more performance curves are received from one or more treatment providers 108. The trainer 112 may update the matching model 130 by applying the machine learning regression technique to the one or more performance curves using data from the set of project parameters 110 to determine real-time performance metrics for the one or more treatments or technologies. Updating the matching model 130 ensures that the levelized value accurately reflects expenditures for the one or more treatments or technologies at a time when the WRM tool 114 is utilized. In some examples, the matching model 130 can be configured to update itself based on the one or more performance curves using data from the set of project parameters 110.

The WRM tool 114 also includes a financial modeler 126 that is configured to receive data characterizing the one or more treatments or technologies for each alternative water resource of the set of alternative water resources determined by the matcher 128. The financial modeler 126 uses a financial model 136 to determine one or more costs associated with water treatment and transportation for each alternative water resource of the set of alternative water resources based on the one or more treatments or technologies. For example, the financial modeler 126 retrieves from the technology costs database 124 the data associated with the one or more treatments or technologies and determines, using the financial model 136, the one or more costs of water treatment and transportation for each alternative water resource of the set of alternative water resources based on the retrieved data.

In a non-limiting example, the financial model 136 is based on a discounted cash flow economic model that calculates a long run marginal cost (LRMC) of water treatment of the one or more alternative water resources and the transportation costs of the one or more alternative water resources to a point of use at the project (e.g., location of the project) based on bulk quantities. The financial model 136 can be generated by the financial modeler 126 based on one or more variables (or assumptions), or economic model. In a non-limiting example, the economic model is based on one or more of the following assumptions:
a treatment plant has a total specifiable production capacity;
water treatment costs include a pump station as well as a pretreatment section based on the one or more treatments or technologies determined by the matcher 128;
a levelized LRMC of the water treatment includes capital expenditures (“CAPEX”) and operational expenditures (“OPEX”) of the treatment units, electric power, manpower and other miscellaneous costs;
a specific energy consumption in kilowatts (kW)/m3 of treated water reflects a design configuration of treatment plants and assumes an efficient energy recovery system where applicable;
a number of labor resources is specifiable;
bulk transport of the one or more alternative water resources to the point of use uses the pump station and a specifiable pipeline capacity;
an average constant elevation profile for the pipeline;
electrical power is used in water resource transmission;
electrical power consumption is calculated considering both the friction head and the static head based on a specified empirical equation;
pumps power consumption is dictated by the hydraulic power to overcome the friction head losses caused by the flow of the water resource in the piping as well as the static head associated with the difference in elevation between the treatment plant at an intake of the water resource and the point of use;
capital cost estimates for treatment plants and transmission pipelines are retrieved from the technology costs database 124;
an annual sustaining capital as a specifiable percentage of the CAPEX for each of the treatment plant as well as the water resource transmission system;
energy values based on the energy cost at a specified location captures the real cost of energy consumption;
average annual full salary cost is included in the updatable database based on international published figures;
conventional unit costs for chemicals are at specifiable rates provided by the chemical suppliers;
estimated annual costs for maintenance are as a specifiable percentage of the CAPEX for the treatment plant, the pump station, and the pipeline and includes external services for maintenance and operation of the treatment plant such as costs for external workshop as well as spare parts;
estimated costs for insurance are as a specifiable percentage of the CAPEX per annum;
a specifiable escalation rate is based on US published inflation rates; and/or
a specifiable discount rate.

One or more of the assumptions may be stored in the technology costs database 124, for example. One or more of the specifiable values may be received as an input. A user may use a UI as described with respect to FIG. 4 to provide the input, for example.

In certain embodiments, the financial modeler 126 can be configured to receive a set of project parameters 110. The financial modeler 126 may update one or more of the assumptions based on data from the set of project parameters 110. In another non-limiting example, one or more of the assumptions may be modified by a user using a UI as described below with respect to FIG. 4. The financial modeler 126 may cause the modifications to be stored to the technology costs database 124, for example. The financial modeler 126 may use the modified assumptions to modify the financial model 136.

The WRM tool 114 also includes a levelized value engine 132 that is configured to receive data characterizing the set of alternative water resources from the treatment identifier 122, data characterizing the one or more treatments or technologies from the matcher 128, and data characterizing the one or more costs of water treatment and transportation from the financial modeler 126. The levelized value engine 132 is to determine the levelized value 116 for the water resource. The determined levelized value can be used to cause one or more of the set of alternative water resources and/or the water resource to be delivered to (or used at) a project or site. In certain embodiments, the levelized value 116 is equivalent to an alternative water resource of the set of alternative water resources having the least cost when compared to the other alternative water resources of the set of alternative water resources.

In some embodiments, for each combination of an alternative water resource of the set of alternative water resources and each applicable treatment or technology associated with the alternative resource, the levelized value engine 132 calculates a cost of pumping the output of a treatment plant associated with each treatment or technology of the one or more treatments or technologies over a distance and up an elevation to the project location, a cost of treatments such that the alternative water resource is to have a set of water characterizations within a specified range of the set of water characterizations for the water resource, and a cost of the water resource. In a non-limiting example, the cost of the alternative water resource may be assumed to be zero due to a quantity or sustainability rate of the alternative water resource. The levelized value engine then sums the cost calculations. For example, the levelized value engine 132 may use the following equation for each combination: Total Cost=Pumping Costs+Treatment Costs+Cost of Alternative Water Resource. The levelized value engine 132 can compare the sums of the cost calculations for each combination of an alternative water resource of the set of alternative water resources and each applicable treatment or technology associated with the alternative resource. The levelized value engine 132 determines the levelized value for the water source is equal to the alternative water resource of the set of alternative water resources having the lowest sum of cost calculations.

In some embodiments, the determined levelized value is a first levelized value, and is used to cause a first alternative water resource of the set of alternative water resources to be delivered to the project. The levelized value engine 132 determines a second levelized value for the first alternative water resource based on data identifying the set of alternative water resources, data characterizing the one or more treatments or technologies, and data characterizing one or more expenditures of water treatment and transportation for each alternative water resource. In a non-limiting example, the second levelized value is then used to cause a second alternative water resource of the set of alternative water resources to be delivered to the project to replace and/or supplement the first alternative water resource. In another non-limiting example, the first alternative water resource and the second alternative resource are blended. The term “blend,” or its derivatives used herein, indicates a mixture of two or more water resources. The blend may be described using percentages or a ratio of volumes of each water resource of the blend, for example.

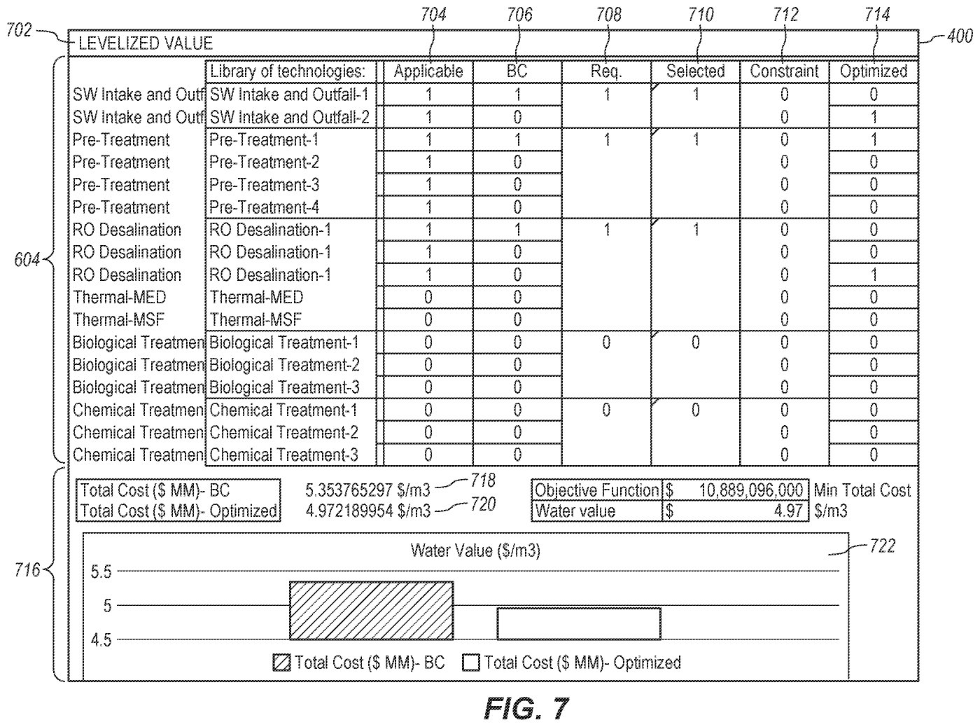

In various embodiments, the levelized value engine 132 generates one or more flags associated with the set of alternative water resources and the data characterizing one or more treatments or technologies. The levelized value engine 132 provides a flag that indicates whether each treatment or technology of the one or more treatments or technologies is applicable to each alternative of the set of alternative water resources. The levelized value engine 132 determines a flag that indicates whether each treatment or technology is used in a base case. An alternative water resource having a set of water characteristics similar to the set of water characteristics of the water resource being utilized or is being considered can be referred to as the base case. However, the base case is not necessarily the most cost-effect alternative water resource of the set of alternative water resources. In a non-limiting example, the base case is a first alternative water resource of the set of alternative water resources determined to have the set of water characterizations after receiving one or more treatments. The levelized value engine 132 provides a flag that indicates whether each treatment or technology is required to achieve the set of water characterizations specified. The levelized value engine 132 provides a flag that indicates whether a type of treatment or technology is used in determination of the levelized value 116. The levelized value engine 132 provides a flag that indicates whether each treatment or technology is associated with an operational constraint. The levelized value engine 132 provides a flag that indicates whether each treatment or technology is used in determining the levelized value 116. One or more flags and corresponding data, as disclosed herein (e.g., see FIG. 7), can be provided and rendered on an output device, such as a display, as disclosed herein.

In certain embodiments, the levelized value engine 132 is to generate a water usage plan 118 based on one or more of the levelized value 116, the set of alternative water resources identified by the treatment identifier 122, the one or more treatments or technologies determined by the matcher 128, and the one or more costs of water treatment and transportation determined by the financial modeler 126. The water usage plan 118 can provide data recommending one or more water resources for use during the project lifecycle. For example, the water usage plan may recommend a first water resource for use during a construction phase of a project and a second water resource for use during an operation phase of the project. In another non-limiting example, the water usage plan may recommend a blend of a first water resource and a second water resource for use during a construction phase of a project and a third water resource for use during an operation phase of the project. In some examples, the water usage plan 118 can specify an amount of or percentage of water resource as a ratio for the blend. Thus, the WRM tool 114 can be used to predict a water usage plan that identifies one or more best or optimal water resources to use, which can improve a project efficiency and in some instances preserve project equipment.

In certain embodiments, the levelized value engine 132 is to generate at least one water resource selection command 120 based on the water usage plan 118, The water resource selection command 120 can select from the water resource having the set of water characterizations 106, the set of alternative water resources, or a combination thereof. Generating the at least one water resource selection command 120 may include issuing the command for delivery and potential execution. Execution of the at least one water resource selection command 120 may result in opening a valve to enable flow of the at least one water resource, for example. In another non-limiting example, execution of the at least one water resource selection command 120 may result in blending of one or more water resources. In further non-limiting examples, the at least one water resource selection command 120 may be generated for one or more stages of the project lifecycle, multiple times during a single stage of the project lifecycle, or a combination thereof. For example, a first stage of the project lifecycle may use a first water resource while a second stage of the project lifecycle may use a first alternative water resource that is a blend of the first water resource and a second water resource as well as use a second alternative water resource that is a third water resource. Through the use of the WRM tool 114, valves and/or equipment can be automatically controlled to deliver one or more water resources to a project site, or facility based on the on the water resource selection command 120.

In certain embodiments, the WRM tool 114 may be used to determine a levelized value 116 for different water resources. For example, the treatment identifier 122 can identify a second set of alternative water resources based on a second location of a second project and on a second set of water characterizations 106 of a second water resource. The matcher 128 is to determine, using the matching model 130, a second set of one or more treatments or technologies for each alternative water resource of the second set of alternative water resources based on the second set of water characterizations 106. The financial modeler 126 is to determine, using the financial model 136, a second set of one or more costs of water treatment and transportation for each alternative water resource of the second set of alternative water resources based on the second set of one or more treatments or technologies. The levelized value engine 132 is to determine a second levelized value of the second water resource based on the second set of alternative water resources, the second set of one or more treatments or technologies, and the second set of one or more costs of water treatment and transportation.

In various embodiments, the WRM tool 114 may be used to determine a billing structure for one or more of the project, or other projects upstream, downstream, or in an otherwise specified area or region of the project. In a non-limiting example, the levelized value engine 132 is to generate the billing structure based on one or more of the levelized value 116 or the water usage plan 118 of the project, the other projects, or a combination thereof. In a non-limiting example, a governmental entity may use the billing structure to assist in conserving scarce water resources.

In other embodiments, the WRM tool 114 may generate a recommendation that a governmental entity restrict water usage. Restricting water usage includes limiting water usage as well as a partial or full ban of water usage by one or more of the project, the other projects, one or more existing industries in a specified area or region, or for residential uses in the specified area or region. In a non-limiting example, the levelized value engine 132 is to generate the recommendation based on one or more of the levelized value 116 or the water usage plan 118 of the project, the other projects, or a combination thereof. In a non-limiting example, the levelized value engine 132 may determine that the water resource, one or more alternative water resources of the set of alternative resources, or a combination thereof will degrade in quality and/or quantity. The levelized value engine 132 may make the determination based on one or more of the levelized value 116 or the water usage plan 118 of the project, the other projects, or a combination thereof, for example.

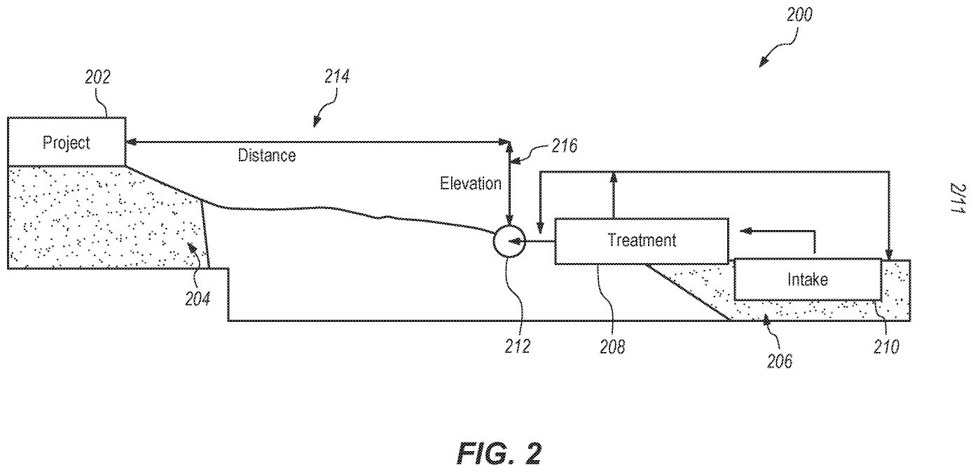

FIG. 2 is a block diagram of a system 200 implementing a WRM tool, in accordance with certain embodiments. The WRM tool may be the WRM tool 114 of FIG. 1, for example. In a non-limiting example, the treatment identifier of the WRM tool is to identify a set of alternative water resources based on a location 202 of a project using a water resource 204 and on a set of water characterizations of the water resource 204. The matcher of the WRM tool is to determine, using a matching model, one or more treatments or technologies for each alternative water resource of the set of alternative water resources based on the set of water characterizations. The matcher may determine that the set of alternative water resources includes the water resource 206, for example. The financial modeler of the WRM tool is to determine, using a financial model, one or more costs of water treatment and transportation for each alternative water resource of the set of alternative water resources based on the one or more treatments or technologies. The financial modeler may determine one or more costs of treatment of the water resource 206 based on one or more treatments or technologies used by a treatment plant 208 having an intake system 210 as well as on a distance 214 and elevation 216 from an output 212 of the treatment plant 208 to the location 202, for example. The levelized value engine of the WRM tool is to determine a levelized value for the water resource 204 based on the set of alternative water resources, the one or more treatments or technologies, and the one or more costs of water treatment and transportation. The levelized value engine of the WRM tool may calculate a cost of pumping the output 212 of the treatment plant 208 over the distance 214 and up the elevation 216, a cost of treating the water resource 206 to have a set of water characterizations within a specified range of the set of water characterizations for the water resource 204, and a cost of the water resource 206. The levelized value engine of the WRM tool may then generate the levelized value for the water resource 204 by summing the cost calculations. In a non-limiting example, the cost of the water resource 206 may be assumed to be zero due to a quantity or sustainability rate of the water resource 206.

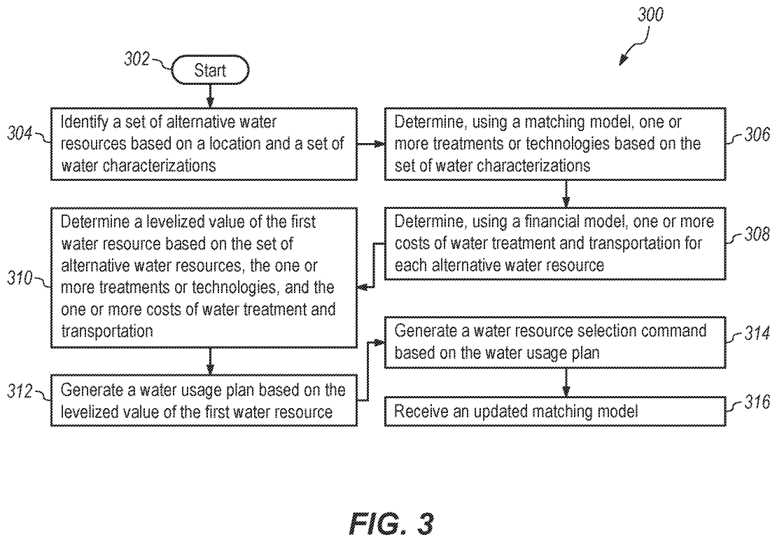

In certain embodiments, the WRM tool 114 operates in accordance with the workflow 300 shown in FIG. 3, beginning at 302. At 304, an identification of a set of alternative water resources based on a location of a project (e.g., location 202 of FIG. 2) having a water resource (e.g., water resource 204 of FIG. 2) and on a set of water characterizations of the water resource is made by treatment identifier 122. At 306, a determination, using the matching model 130, of one or more treatments or technologies (e.g., treatment plant 208, intake system 210 of FIG. 2) for each alternative water resource (e.g., water resource 206 of FIG. 2) of the set of alternative water resources based on the set of water characterizations is made by matcher 128. At 308, a determination, using the financial model 136, of one or more costs of water treatment and transportation for each alternative water resource of the set of alternative water resources based on the one or more treatments or technologies is made by financial modeler 126. At 310, a levelized value 116 of the water resource is determined by the levelized value engine 132 based on the set of alternative water resources, the one or more treatments or technologies, and the one or more costs of water treatment and transportation. At 312, a water usage plan 118 is generated by the levelized value engine 132 based on the levelized value 116 of the first water resource. At 314, a water resource selection command 120 to select at least one water resource from the first water resource and the set of alternative water resources is generated by the levelized value engine 132 based on the water usage plan 118.

As seen in workflow 300, the WRM tool 114 is further operable to receive an updated matching model, at 316. Subsequent executions of the workflow 300 utilize the updated matching model to ensure that the WRM tool 114 is responsive to changes in technologies, treatments, and water resource availability and usage. The workflow 300 can be repeated periodically to identify new alternative water resources based on newly-acquired treatments or technologies or new facilities.

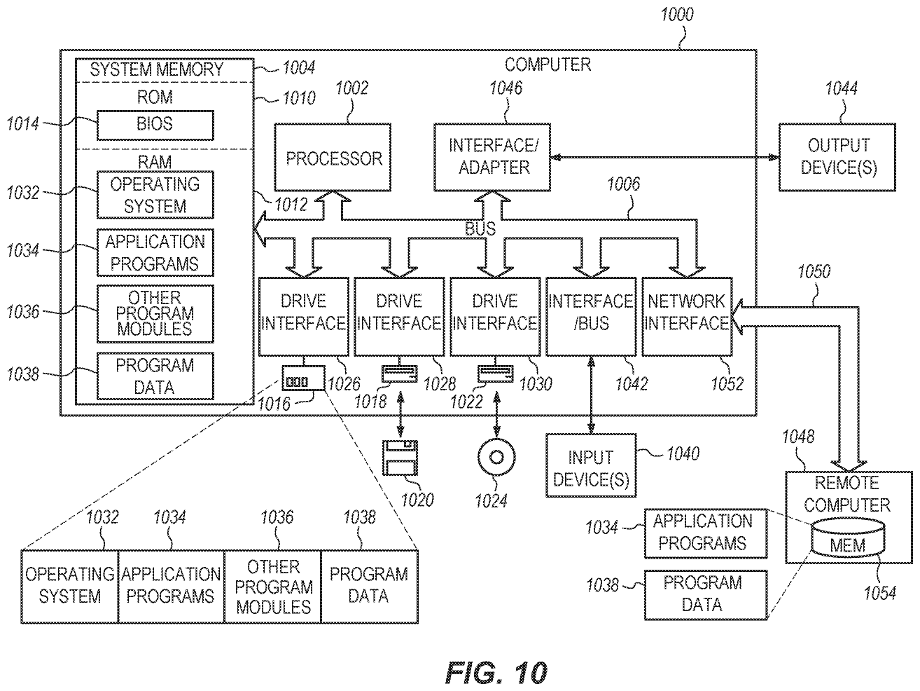

FIG. 4 is an example user interface (UI) 400 for a WRM tool (e.g., WRM tool 114 of FIG. 1), in accordance with certain embodiments. UI 400 is an example user interface generated by the WRM tool. In a non-limiting example, UI 400 is generated by the WRM tool and displayed on a display device of a computer system, such as computer system 1000 of FIG. 10. UI 400 includes page 402 that identifies the page displayed by the UI. A title of page 402 identifies the page as “Input Data.” In various embodiments, the page 402 enables the user to input data used by the WRM tool. The data may be specifiable data as described with respect to FIG. 1, 2, or 3, for example. Page 402 includes inputs 404, 406, 408, 410, 412, 414 and interactive buttons 416, 418.

In certain embodiments, input 404 enables the user to specify data of a set of water characterizations. In a non-limiting example, the data includes TDS, turbidity, COD, BOD, microorganisms, and heavy metals. However, input 404 may enable the user to specify other data of the set of water characterizations described herein. Input 406 enables the user to specify a water resource for which the WRM tool is to determine a levelized value. In a non-limiting example, the water resource is specified by type, such as groundwater. In another non-limiting example, the water resource is specified by an identifier associated with a geographical location specified in input 410. Input 408 enables the user to specify a water quantity for a project. In a non-limiting example, the water quantity is a desired amount of water for a planned project in cubic meters per day (m³/day). In another non-limiting example, the water quantity is a known amount of water used in daily operations of an existing facility. Input 410 enables the user to specify a geographical location. In a non-limiting example, the geographical location includes a maximum distance and elevation difference from sea level from which to source the alternative water resource. In another non-limiting example, the geographical location includes a region for the planned project. Input 412 enables the user to specify financial inputs. In a non-limiting example, the financial inputs include a discount rate, a tax rate, a depreciation rate, a CAPEX inflation rate, and a OPEX inflation rate. Input 414 enables the user to specify an alternative water resource which the WRM is to consider when determining the levelized value. In a non-limiting example, the alternative water resource is specified by type, such as seawater. In another non-limiting example, the alternative water resource is specified by an identifier associated with a geographical location specified in input 410. In a non-limiting example, input 414 also enables the user to specify a set of water characterizations for the alternative water resource. In another non-limiting example, input 414 enables the user to specify tolerances for respective data of the set of water characterizations of input 404.

In various embodiments, interactive button 416 enables the user to command the WRM tool to determine a base case for the levelized value using the specified inputs. In a non-limiting example, in response to the user selecting interactive button 416, the WRM tool 114 may cause one or more of page 502 described with respect to FIG. 5 or page 602 described with respect to FIGS. 6A-6B to display. Interactive button 418 enables the user to command the WRM tool 114 to determine the levelized value using the specified inputs. In a non-limiting example, in response to the user selecting interactive button 418, the WRM tool may cause page 702 to display.

FIG. 5 is example UI 400 for the WRM tool 114, in accordance with certain embodiments. UI 400 includes page 502 that identifies the page displayed by the UI. A title of page 502 identifies page 502 as “Technology Matching.” Page 502 includes viewing area 504 and viewing area 510 as well as interactive buttons 416, 418 described with respect to FIG. 4.

In various embodiments, page 502 enables the user to view one or more of the set of water characterizations, the set of alternative water resources, water quantity for the project, or whether treatment is required in viewing area 504. In a non-limiting example, area 506 of viewing area 504 includes the set of water characterizations for the water resource and the set of water characterizations for the alternative water resource specified on page 402 shown in FIG. 4. Area 506 also displays a determination of whether the alternative water resource requires one or more treatments based on a comparison of the sets of water characterizations. In some embodiments, viewing area 504 enables the user to view the set of alternative water resources available in area 508. In a non-limiting example, area 508 displays alternative water resources other than the type specified on page 402 shown in FIG. 4. In another non-limiting example, area 508 includes each alternative water resource of the set of alternative water resources identified by the treatment identifier 122 as described with respect to FIG. 1. The additional water resources may include wastewater or steam, for example. A maximum amount 516 of each alternative water resource may also be displayed in area 508.

In various embodiments, page 502 enables the user to view one or more of the treatments or technologies to treat the set of alternative water resources or the base case in viewing area 510. The one or more treatments or technologies may be determined by the matcher 128 as described with respect to FIG. 1 and then displayed in area 512, for example. In a non-limiting example, in response to the user selecting interactive button 416, the WRM tool 114 may determine costs associated with the base case and then display the base case in area 514.

FIGS. 6A-6B is example UI 400 for the WRM tool 114, in accordance with certain embodiments. UI 400 includes page 602 that identifies the page displayed by the UI. A title of page 602 identifies the page as “Financials.” Page 602 includes viewing area 604 as well as interactive buttons 416, 418 described with respect to FIG. 4.

In various embodiments, page 602 enables the user to view the costs associated with each treatment or technology available to treat the set of alternative water resources to achieve a similar set of water characterizations as the water resource specified for the project. The costs may be determined by financial modeler 126, for example. In a non-limiting example, in response to the user selecting interactive button 416, the WRM tool 114 may highlight each cost associated with the base case. In another non-limiting example, in response to the user selecting interactive button 418, the WRM tool may highlight each cost associated with the levelized value. In other examples, in response to the user selecting either interactive button 416, 418, the WRM tool 114 may cause page 702 shown in FIG. 7 to display.

FIG. 7 is example UI 400 for the 114 WRM tool, in accordance with certain embodiments. UI 400 includes page 702 that identifies the page displayed by the UI. A title of page 702 identifies the page as “Levelized Value.” Page 702 includes viewing area 604 described with respect to FIGS. 6A-6B and viewing area 716.

In some embodiments, columns 704, 706, 708, 710, 712, 714 are appended to viewing area 604 to show operation of the levelized value engine 132 described with respect to FIG. 1. Column 704 includes a flag that indicates whether the treatment or technology is applicable. Column 706 includes a flag that indicates whether each treatment or technology is used in the base case. Column 708 includes a flag that indicates whether each treatment or technology is required to achieve the set of water characterizations specified. Column 710 includes a flag that indicates whether each treatment or technology is selected by the levelized value engine. Column 712 includes a flag that indicates whether each treatment or technology is associated with a constraint. Column 714 includes a flag that indicates whether each treatment or technology is used by the levelized value case. Comparison of data of columns 706 and 714 demonstrate that the levelized value is determined using treatments or technologies that differ from those used in the base case.

In various embodiments, viewing area 716 includes total base case cost 718, total levelized value case cost 720 and graph 722. Graph 722 is a graphical comparison of the base case and the levelized value case.

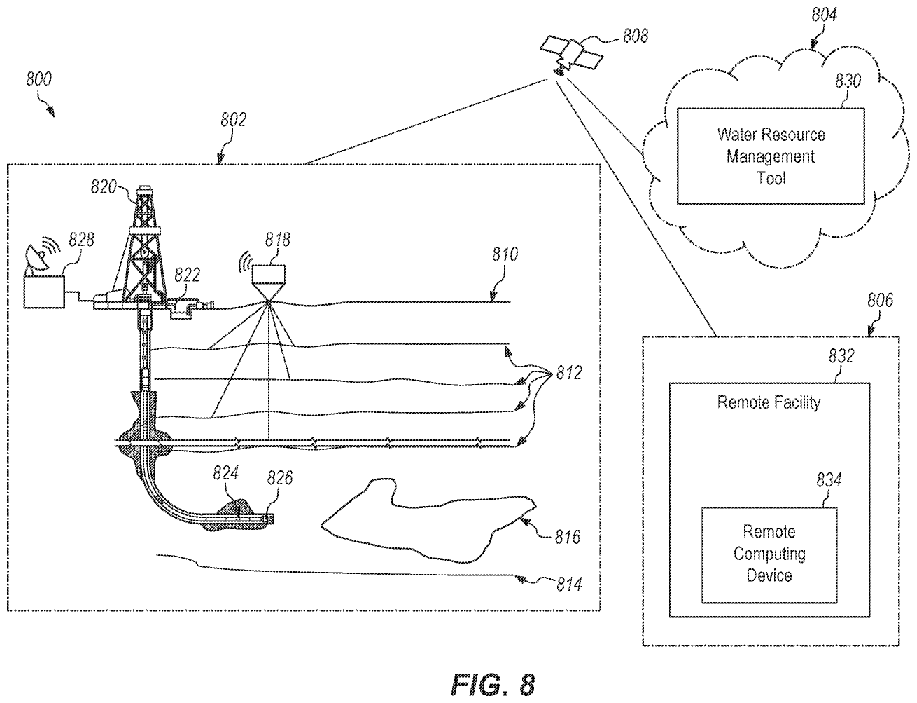

FIG. 8 is a block diagram of a system 800 that can be employed to implement a system including a WRM tool 830, in accordance with certain embodiments. The WRM tool 830 may be the WRM tool 114 of FIG. 1, for example. In one or more examples, one or more of the elements shown in FIG. 8 may be omitted, repeated, replaced with similar elements, and or substituted. Accordingly, embodiments should not be considered limited to the specified arrangement of elements shown in FIG. 8.

System 800 includes a field 802, a cloud system 804, a remote system 806, and a communication relay 808. The communication relay 808 may include one or more components that enable remote communications. The components may include satellites, antennas, routers, repeaters, modems, fiber optic cabling, coaxial cabling, or other like electronic, wireless, or optical networking technologies that enable communications over distances.

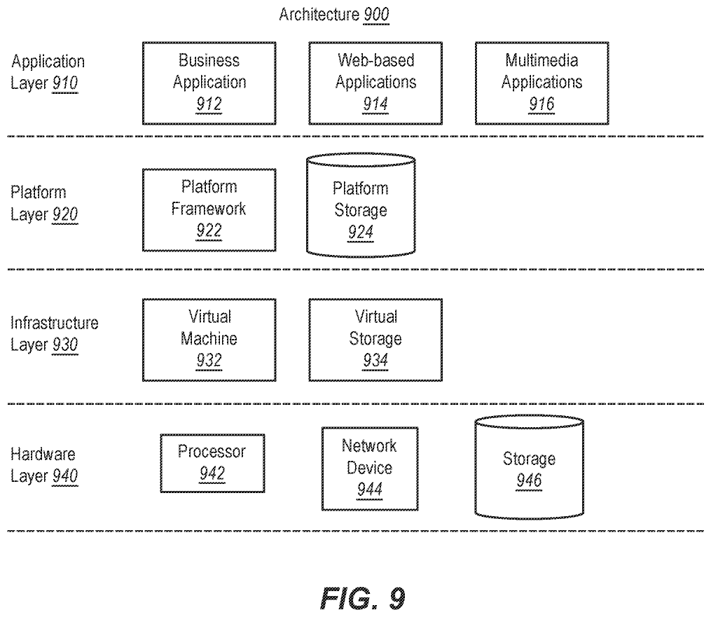

While the field 802 is an onshore field, or a field having resources within a subterranean land formation, in other examples, the field 802 is an offshore field, or a field having resources within a subsea or underwater formation. In other examples, the system 800 includes one or more onshore fields, one or more offshore fields, and/or a combination thereof. For example, the remote project 832 of the remote system 806 may be a second onshore field. The field 802 is communicatively coupled to one or more of the cloud system 804 and the remote system 806 via the communication relay 808, for example. The cloud system 804 provides resources over the internet. The cloud system 804 may be a cloud-provider system as shown in FIG. 9, for example. In a non-limiting example, the remote system 806 may be a system for controlling one or more operations of the field 802. The remote system 806 may include a computing device 834 for controlling the one or more operations of the field 802, for example. The computing device 834 may be the computer system shown in FIG. 10, for example.

The field 802 includes a subterranean formation 810 having multiple sedimentary layers 812, one or more fault lines 814, and one or more resources 816. The multiple sedimentary layers, one or more fault lines 814, and one or more resources 816 may be detected using a seismic source, such as source 818, a well logging tool, such as well logging tool 824 having a drill bit 826, or a combination thereof. The field 802 also includes a well 820 using a water resource 822 and having a control system 828. The water resource may be the water resource 204 of FIG. 2, for example.

In certain embodiments, the control system 828 may be communicatively coupled to WRM tool 830 via the communication relay 808. The control system 828 may transmit inputs such as the location and identity of the water resource 822. In a non-limiting example, the control system 828 may receive one or more of a levelized value for the water resource 822, a water usage plan (e.g., the water usage plan 118 of FIG. 1), or a water resource selection command (e.g., the water resource selection command 120 of FIG. 1) from the WRM tool 830. In some embodiments, the control system 828 may include a display device, as described with respect to FIG. 10, for example, that enables an operator of the field 802 to execute the water usage plan or the water resource selection command. In other embodiments, the control system 828 may execute the water usage plan or the water resource selection command.

FIG. 9 is a block diagram of an architecture 900 that can be employed to execute a system including a WRM tool, in accordance with certain embodiments described. The WRM tool may be the WRM tool 114 of FIG. 1 or the WRM tool 830 of FIG. 8, for example. The architecture 900 includes an application layer 910, a platform layer 920, an infrastructure layer 930, and a hardware layer 940. The application layer 910 includes one or more of business applications 912, web-based applications 914, and multimedia applications 916. The application layer 910 enables one or more users to interact with data or applications stored by a cloud-service provider. The application layer 910 may be referred to as a front-end. The platform layer 920 includes one or more of a platform framework 922 and a platform storage 924. The platform layer 920 is specified by the cloud-service provider and enables the front-end to communicate with the back-end. The back-end includes the infrastructure layer 930 and the hardware layer 940. The infrastructure layer 930 includes one or more virtual machines 932 and one or more virtual storage devices 934. The infrastructure layer 930 enables the cloud-service provider to use a single physical machine to host multiple virtual machines 932, each of which can act as an independent computer system. The hardware layer 940 includes one or more processors 942, one or more network devices 944, and one or more storage devices 946 to service the infrastructure layer 930. The one or more processors 942 may be a processor as described with respect to FIG. 10. The one or more network devices 944 may be devices which enable network connectivity, as described with respect to FIG. 4 or 6. The one or more storage devices 946 may be a computer-readable media as described with respect to FIG. 10. Architecture 900 increases flexibility and efficiency by enabling companies to use only the resources needed to perform particular functions.

In certain embodiments a UI of a business application 912 or a web-based application 914 may enable a user to enter one or more inputs to the WRM tool. The one or more inputs may be one or more of the location of the project, the set of water characterizations 106, data of one or more treatments or technologies, the set of project parameters 110, or technology selection criteria, for example. The business application 912 or the web-based application 914 may communicate with the platform framework 922 of the cloud-service provider hosting the WRM tool. The platform framework 922 may include an application programming interface (API) to enable the communication, for example. In response to receiving an instruction to execute the WRM tool, the cloud-service provider may allocate a specified processor capacity and a specified memory from the hardware layer 940 to create a virtual machine 932, a virtual storage 934, or a combination thereof. The virtual machine 932 may enable execution of the WRM tool 114, for example. The virtual storage 934 may be to store the technology costs database 124, for example.

FIG. 10 is a block diagram of a computer system 1000 that can be employed to execute a system including a WRM tool, in accordance with certain embodiments described. The computer system 1000 may be the system 100 of FIG. 1, the control system 828 of FIG. 8, the remote computing device 834 of FIG. 8, for example. Computer system 1000 can be implemented on one or more general purpose networked computer systems, embedded computer systems, routers, switches, server devices, client devices, various intermediate devices/nodes or standalone computer systems. Additionally, computer system 1000 can be implemented on various mobile clients such as, for example, a personal digital assistant (PDA), a smartphone, a laptop computer, a pager, and the like, provided it includes sufficient processing capabilities.

Computer system 1000 includes processing unit 1002, system memory 1004, and system bus 1006 that couples various system components, including the system memory 1004, to processing unit 1002. Dual microprocessors and other multi-processor architectures also can be used as processing unit 1002. System bus 1006 may be any of several types of bus structure including a memory bus or memory controller, a peripheral bus, and a local bus using any of a variety of bus architectures. System memory 1004 includes read only memory (ROM) 1010 and random access memory (RAM) 1012. A basic input/output system (BIOS) 1014 can reside in ROM 1010 containing the basic routines that help to transfer information among elements within computer system 1000. In other examples, a Unified Extensible Firmware Interface (UEFI) or other set of specifications defining platform architecture and firmware includes the basic routines that help to transfer information among elements within computer system 1000.

Computer system 1000 can include a hard disk drive 1016, magnetic disk drive 1018, e.g., to read from or write to removable disk 1020, and an optical disk drive 1022, e.g., for reading CD-ROM disk 1024 or to read from or write to other optical media. Hard disk drive 1016, magnetic disk drive 1018, and optical disk drive 1022 are connected to system bus 1006 by a hard disk drive interface 1026, a magnetic disk drive interface 1028, and an optical drive interface 1030, respectively. The drives and associated computer-readable media provide nonvolatile storage of data, data structures, and computer-executable instructions for computer system 1000. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more components of embodiments shown and described herein.

A number of program modules may be stored in drives and RAM 1012, including operating system 1032, one or more computer application programs 1034, other program modules 1036, and program data 1038. In some examples, the computer application programs 1034 can include one or more of the WRM tool 114 and trainer 112 of FIG. 1, for instance, and the program data 338 can include one or more of the water resource identifier 102, water characterizations 106, data from the treatment provider 108, project parameters 110, levelized value 116, water usage plan 118, water resource selection command 120, matching model 130, and financial model 136 of FIG. 1, for instance. The application programs 1034 and program data 1038 can include functions and methods programmed to manage water resources, such as shown and described herein.

A user may enter commands and information into computer system 1000 through one or more input devices 1040, such as a pointing device (e.g., a mouse, touch screen), keyboard, microphone, joystick, game pad, scanner, and the like. These and other input devices 1040 are often connected to processing unit 1002 through a corresponding port interface 1042 that is coupled to the system bus, but may be connected by other interfaces, such as a parallel port, serial port, or universal serial bus (USB). One or more output devices 1044 (e.g., display, a monitor, printer, projector, or other type of displaying device) is also connected to system bus 1006 via interface 1046, such as a video adapter.

Computer system 1000 may operate in a networked environment using logical connections to one or more remote computers, such as remote computer 1048. Remote computer 1048 may be a workstation, computer system, router, peer device, or other common network node, and typically includes many or all the elements described relative to computer system 1000. The logical connections, schematically indicated at 1050, can include a local area network (LAN) and a wide area network (WAN). When used in a LAN networking environment, computer system 1000 can be connected to the local network through a network interface or adapter 1052. When used in a WAN networking environment, computer system 1000 can include a modem, or can be connected to a communications server on the LAN. The modem, which may be internal or external, can be connected to system bus 1006 via an appropriate port interface. In a networked environment, computer application programs 1034 or program data 1038 depicted relative to computer system 1000, or portions thereof, may be stored in a remote memory storage device 1054.

In view of the foregoing structural and functional description, those skilled in the art will appreciate that portions of the embodiments described herein may be implemented as a method, data processing system, or computer program product (e.g., computer application). Accordingly, these portions of the present disclosure may take the form of an entirely hardware embodiment, an entirely software embodiment, or an embodiment combining software and hardware, such as shown and described with respect to the computer system of FIG. 10. Furthermore, portions of the embodiments herein may be a computer program product on a computer-readable medium having computer-readable program code on the medium. Any suitable non-transitory computer-readable medium may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other integrated circuit (IC) (such, as for example, a field-programmable gate array (FPGA) or an application-specific integrated circuit (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), a magnetic tape, a holographic storage medium, a solid-state drive (SSD), a RAM drive, a SECURE DIGITAL card, a SECURE DIGITAL drive, or another suitable computer-readable medium or a combination of two or more of these, where appropriate. A non-transitory computer-readable medium may be volatile, nonvolatile, or a combination of volatile and non-volatile, as appropriate.

Certain embodiments described herein have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks. These computer-executable instructions may also be stored in a computer-readable medium that can direct a computer or other programmable data processing apparatus to function in a particular manner, such that the instructions stored in the computer-readable medium result in an article of manufacture including instructions which implement the function specified in the flowchart block or blocks. The computer-executable instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

### Additional Embodiments

### Embodiments Disclosed Herein Include

A. A water resource management (WRM) tool includes an identifier, executed by a processor, to generate data identifying a set of alternative water resources for a project based on data characterizing a location of the project using a water resource and data characterizing a set of water characterizations of the water resource, a matcher, executed by the processor, to match, using a matching model, one or more treatments or technologies to each alternative water resource of the set of alternative water resources based on the set of water characterizations, and a levelized value engine, executed by the processor, to determine a levelized value for the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project.

B. A method for water resource management includes identifying a set of alternative water resources for a project based on data characterizing a location of the project using a water resource and data characterizing a set of water characterizations of the water resource, matching one or more treatments or technologies to each alternative water resource of the set of alternative water resources based on the set of water characterizations, and determine a levelized value for the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project.

C. A non-transitory computer-readable medium storing computer-executable instructions, which, when executed by a processor, cause the processor to identify a set of alternative water resources for a project based on data characterizing a location of the project using a water resource and data characterizing a set of water characterizations of the water resource, match one or more treatments or technologies to each alternative water resource of the set of alternative water resources based on the set of water characterizations, and determine a levelized value for the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project.

Each of embodiments A through C may have one or more of the following additional elements in any combination: Element 1: where the levelized value engine is further configured to determine a pumping cost for each alternative water resource based on a distance and an elevation from a treatment location to a location of the project; determine a treatment cost of treatments such that each alternative water resource is to have a set of water characterizations within a specified range of the set of water characterizations for the water resource; and determine a cost of each alternative water resource. Element 2: where the determined levelized value is a first levelized value, and is used to cause a first alternative water resource of the set of alternative water resources to be delivered to the project, and where the levelized value engine is configured to determine a second levelized value for the first alternative water resource based on data identifying the set of alternative water resources, data characterizing the one or more treatments or technologies, and data characterizing one or more expenditures of water treatment and transportation for each alternative water resource, the second levelized value being used to cause a second alternative water resource of the set of alternative water resources to be delivered to the project to replace and/or supplement the first alternative water resource. Element 3: where the set of water characterizations includes at least one of a total dissolved solid, a turbidity, a carbonate level, a potential of hydrogen (pH) level, a hardness, a sodium level, a chloride level, a nitrate level, a microorganism presence, a heavy metal content, a toxin content, a pollutant content, a sodium absorption rate. Element 4: where the levelized value engine is further configured to generate a water usage plan based on the levelized value for the water resource, the set of alternative water resources, the one or more treatments or technologies, and the one or more costs of water treatment and transportation. Element 5: where the levelized value engine is further configured to generate at least one water resource selection command based on the water usage plan, wherein the at least one water resource selection command is to select for use by the project at least one water resource from the water resource and the set of alternative water resources. Element 6: where the at least one water resource selection command is to control one or more valves supplying water resources to the project. Element 7: where the identifier is further configured to identify a second set of alternative water resources based on a second location of a second project using a second water resource and on a second set of water characterizations of the second water resource, where the matcher is further configured to determine, using the matching model, a second set of one or more treatments or technologies for each alternative water resource of the second set of alternative water resources based on the second set of water characterizations, and where the levelized value engine is further configured to determine a second levelized value for the second water resource based on the second set of alternative water resources, the second set of one or more treatments or technologies, and the second set of one or more costs of water treatment and data characterizing one or more expenditures of water treatment and transportation for each alternative water resource of the second set of alternative resources. Element 6: where the matching model is provided by a trainer, and wherein the trainer is configured to train the matching model based on one or more performance curves of the one or more treatments or technologies. Element 8: where the trainer is further configured to update the matching model based on the levelized value for the water resource, a set of project parameters, data associated with the one or more treatments or technologies, or a combination thereof. Element 9: further including a technology costs database configured to receive the data characterizing the one or more treatments or technologies, where the data includes one or more of a plurality of water resources, water characterizations of each water resource of the plurality of water resources, a set of treatments, costs associated with each treatment of the sets of treatments, a set of technologies, or costs associated with each technology of the set of technologies. Element 10: generating a water usage plan based on the levelized value for the water resource, the set of alternative water resources, the one or more treatments or technologies, and the one or more costs of water treatment and transportation. Element 11: generating at least one water resource selection command based on the water usage plan, wherein the at least one water resource selection command is to select for use by the project at least one water resource from the water resource and the set of alternative water resources. Element 12: controlling one or more valves supplying water resources to the project using the at least one water resource selection command. Element 13: training the matching model based on one or more performance curves of the one or more treatments or technologies. Element 14: updating the matching model based on one or more of the levelized value for the first water resource, a set of project parameters, or data associated with the one or more treatments or technologies. Element 15: generate a water usage plan based on the levelized value for the water resource, the set of alternative water resources, the one or more treatments or technologies, and the one or more costs of water treatment and transportation; and generate at least one water resource selection command based on the water usage plan, wherein the at least one water resource selection command is to select for use by the project at least one water resource from the water resource and the set of alternative water resources. Element 16: control one or more valves supplying water resources to the project using the at least one water resource selection command. Element 17: generating the matching model based on one or more performance curves of the one or more treatments or technologies.

By way of non-limiting example, exemplary combinations applicable to A through C include: Element 4 with Element 5; Element 4 with Element 6; Element 5 with Element 6; Element 7 with Element 8; Element 10 with Element 11; Element 15 with Element 16; Element 15 with Element 17; and Element 16 with Element 17.

The terminology used herein is for the purpose of describing particular embodiments only and is not intended to limit this disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. Also, the phraseology and terminology used herein is for the purpose of description and should not be regarded as limiting. The use of “including,” “comprising,” “having,” “containing,” “involving,” and variations thereof herein, is meant to encompass items listed thereafter and equivalents thereof as well as additional items. While the disclosure has described several exemplary embodiments, it will be understood by those skilled in the art that various changes can be made, and equivalents can be substituted for elements thereof, without departing from the spirit and scope of the invention.

In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A water resource management (WRM) tool comprising:
an identifier, executed by a processor, to generate data identifying a set of alternative water resources for a project based on data characterizing a location of the project using a water resource and data characterizing a set of water characterizations of the water resource;
a matcher, executed by the processor, to match, using a matching model, one or more treatments or technologies to each alternative water resource of the set of alternative water resources based on the set of water characterizations; and
a levelized value engine, executed by the processor, to determine a levelized value for the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project.

2. The WRM tool of claim 1, wherein the levelized value engine is further configured to:
determine a pumping cost for each alternative water resource based on a distance and an elevation from a treatment location to a location of the project;
determine a treatment cost of treatments such that each alternative water resource is to have a set of water characterizations within a specified range of the set of water characterizations for the water resource; and
determine a cost of each alternative water resource.

3. The WRM tool of claim 1, wherein the determined levelized value is a first levelized value, and is used to cause a first alternative water resource of the set of alternative water resources to be delivered to the project, and
wherein the levelized value engine is configured to determine a second levelized value for the first alternative water resource based on data identifying the set of alternative water resources, data characterizing the one or more treatments or technologies, and data characterizing one or more expenditures of water treatment and transportation for each alternative water resource,
the second levelized value being used to cause a second alternative water resource of the set of alternative water resources to be delivered to the project to replace and/or supplement the first alternative water resource.

4. The WRM tool of claim 1, wherein the set of water characterizations includes at least one of a total dissolved solid, a turbidity, a carbonate level, a potential of hydrogen (pH) level, a hardness, a sodium level, a chloride level, a nitrate level, a microorganism presence, a heavy metal content, a toxin content, a pollutant content, a sodium absorption rate.

5. The WRM tool of claim 1, wherein the levelized value engine is further configured to generate a water usage plan based on the levelized value for the water resource, the set of alternative water resources, the one or more treatments or technologies, and the one or more costs of water treatment and transportation.

6. The WRM tool of claim 5, wherein the levelized value engine is further configured to generate at least one water resource selection command based on the water usage plan, wherein the at least one water resource selection command is to select for use by the project at least one water resource from the water resource and the set of alternative water resources.

7. The WRM tool of claim 6, wherein the at least one water resource selection command is to control one or more valves supplying water resources to the project.

8. The WRM tool of claim 1, wherein the matching model is provided by a trainer, and wherein the trainer is configured to train the matching model based on one or more performance curves of the one or more treatments or technologies.

9. The WRM tool of claim 7, wherein the trainer is further configured to update the matching model based on the levelized value for the water resource, a set of project parameters, data associated with the one or more treatments or technologies, or a combination thereof.

10. The WRM tool of claim 1, further comprising a technology costs database configured to receive the data characterizing the one or more treatments or technologies, wherein the data includes one or more of a plurality of water resources, water characterizations of each water resource of the plurality of water resources, a set of treatments, costs associated with each treatment of the sets of treatments, a set of technologies, or costs associated with each technology of the set of technologies.

11. A method for water resource management, comprising:
identifying a set of alternative water resources for a project based on data characterizing a location of the project using a water resource and data characterizing a set of water characterizations of the water resource;
matching, using a matching model, one or more treatments or technologies to each alternative water resource of the set of alternative water resources based on the set of water characterizations; and
determining a levelized value for the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project.

12. The method for water resource management of claim 11, further comprising:
generating a water usage plan based on the levelized value for the water resource, the set of alternative water resources, the one or more treatments or technologies, and the one or more costs of water treatment and transportation.

13. The method for water resource management of claim 12, further comprising:
generating at least one water resource selection command based on the water usage plan, wherein the at least one water resource selection command is to select for use by the project at least one water resource from the water resource and the set of alternative water resources.

14. The method for water resource management of claim 11, further comprising:
controlling one or more valves supplying water resources to the project using the at least one water resource selection command.

15. The method for water resource management of claim 11, further comprising:
training the matching model based on one or more performance curves of the one or more treatments or technologies.

16. The method for water resource management of claim 11, further comprising:
updating the matching model based on one or more of the levelized value for the first water resource, a set of project parameters, or data associated with the one or more treatments or technologies.

17. A non-transitory computer-readable medium storing computer-executable instructions, which, when executed by a processor, cause the processor to:
identify a set of alternative water resources for a project based on data characterizing a location of the project using a water resource and data characterizing a set of water characterizations of the water resource;
match one or more treatments or technologies to each alternative water resource of the set of alternative water resources based on the set of water characterizations; and
determine a levelized value for the water resource based on the data identifying the set of alternative water resources, data characterizing the one or more treatments or technologies, and data characterizing one or more expenditures of water treatment and transportation for each alternative water resource, the determined levelized value being used to cause one or more of the set of alternative water resources and/or the water resource to be delivered to the project.

18. The non-transitory computer-readable medium of claim 17, wherein the processor is further operable to:
generate a water usage plan based on the levelized value for the water resource, the set of alternative water resources, the one or more treatments or technologies, and the one or more costs of water treatment and transportation; and
generate at least one water resource selection command based on the water usage plan, wherein the at least one water resource selection command is to select for use by the project at least one water resource from the water resource and the set of alternative water resources.

19. The non-transitory computer-readable medium of claim 18, wherein the processor is further operable to:
control one or more valves supplying water resources to the project using the at least one water resource selection command.

20. The non-transitory computer-readable medium of claim 19, wherein the processor is further operable to:
generate the matching model based on one or more performance curves of the one or more treatments or technologies.
